(19) United States
(12) Patent Application Publication
(10) Pub. No.: US 2017/0188434 A1
(43) Pub. Date: Jun. 29, 2017

(54) INDOOR AUTOMATIC DIMMING SYSTEM AND METHOD ADAPTIVE TO OUTDOOR LIGHT

(71) Applicant: LUXUL TECHNOLOGY INCORPORATION, New Taipei City (TW)

(72) Inventors: Perng-Fei YUH, New Taipei City (TW); Shiun-Shang CHAN, New Taipei City (TW); Cheng-Hung PAN, New Taipei City (TW)

(73) Assignee: LUXUL TECHNOLOGY INCORPORATION, New Taipei City (TW)

(21) Appl. No.: 15/162,917

(22) Filed: May 24, 2016

(30) Foreign Application Priority Data
Dec. 23, 2015 (TW) 104143275

(51) Int. Cl. H05B 37/02

(52) U.S. Cl. CPC H05B 37/0218; H05B 37/0272

(57) ABSTRACT

An indoor automatic dimming system includes a lamp control module in connection with a controlled lamp, an optical sensor and a mobile device. The optical sensor senses indoor and outdoor luminance and transmits a piece of sensing data to the lamp control module. The mobile device performs a manual mode and an automatic mode. When the manual mode is performed, the lamp control module drives the controlled lamp according to the piece of sensing data and a control signal transmitted from the mobile device. When the automatic mode is performed, the lamp control module receives a configuration parameter transmitted from the mobile device and automatically adjusts luminance of the controlled lamp according to the piece of sensing data and the configuration parameter. Accordingly, the indoor automatic dimming system can instantly sense indoor/outdoor luminance to maintain a balanced luminance indoors and provide operational convenience.

### BACKGROUND OF THE INVENTION

1. Field of the Invention

The present invention relates to a dimming system and method and, more particularly, to an indoor dimming system and method adaptive to outdoor light.

2. Description of the Related Art

Metropolitan areas are full of high-rise buildings. Lighting is undoubtedly one of the basic equipment required for each office of the buildings. Because users of offices may not be familiar with locations of lamp switches, seeking the lamp switches in the dark could be a challenge to everyone. Although conventional lamps can provide light of constant luminance, outdoor natural light may add to indoor lighting effects. However, the outdoor natural light varies with season change all year round and different time of the day. Under the circumstance, indoor light sources with fixed luminance can no longer be treated as ideal light sources and cause more wasted power and a higher electric bill.

The disclosure of Taiwan Patent No. 1487303 entitled “Wireless smart energy conservation two-wire lamp control switch device” (hereinafter “ the conventional lamp control switch”) introduces a smart wireless peripheral lighting control device for a digital home automation system, which is installed at a single gang wall switch box in a traditional two-wire manner for replacing a traditional manually controlled lamp control switch to three sets of lamp control switches. The conventional lamp control switch internally has a human motion infrared sensor, a visible light illumination sensor, a touch panel, a loading current detector, an environment temperature sensor, and a digital radio transceiving module for receiving commands of remote wireless controller, wireless broadband internet control host or mobile network control host to carry out remote switch lamp control of the lamp set loading. Also, switching lamp control of lamp set can be carried out at a proximal end in a manner of human motion infrared sensing or touch control to replace traditional ways of mechanical press.

As can be seen from the conventional technique, as far as varying luminance of outdoor light is concerned, the traditional manually-switching lamp control has the issues of inconvenience incurred from manual lamp switching operation and the resulting energy waste. Although the conventional lamp control switch provides multiple sensors in place of manual lamp switching operation, the conventional lamps with constant luminance fail to meet the demand of adjustable luminance for indoor lighting. Additionally, the sensors have their limitations, are susceptible to environmental factors, and easily trigger false detection.

### SUMMARY OF THE INVENTION

An objective of the present invention is to provide an indoor automatic dimming system and an indoor automatic dimming method that are adaptive to outdoor luminance, simultaneously detect indoor luminance and outdoor luminance through a sensor, and transmit a configuration parameter in a wired or wireless pattern to a lamp control device to automatically adjust the indoor luminance, maintain balanced luminance and enhance operational convenience.

To achieve the foregoing objective, the indoor automatic dimming method is adaptive to outdoor luminance and is performed by an indoor automatic dimming system having an optical sensor, a mobile device and a lamp control module connected to the optical sensor for sensing indoor and outdoor luminance and the mobile device. The mobile device exchanges information with the lamp control module through a communication protocol. The method includes a first manual mode and a first automatic mode. The first manual mode has steps of:

receiving a piece of first sensing data transmitted from the optical sensor and a first control signal transmitted from the mobile device through the lamp control module; and

generating a first driving signal for luminance adjustment through the lamp control module according to the piece of first sensing data and the first control signal.

The first automatic mode has steps of:

transmitting a configuration parameter configured by a user to the lamp control module through the mobile device; and

when the lamp control module receives a piece of second sensing data transmitted from the optical sensor, generating a second driving signal for luminance adjustment according to the piece of second sensing data and the configuration parameter through the lamp control module.

Given the foregoing method, users can perform the first manual mode or the first automatic mode through the mobile device. When the first manual mode is performed, the lamp control module receives the piece of first sensing data transmitted from the optical sensor, the mobile device transmits the first control signal to the lamp control module through the communication protocol, and the lamp control module generates the first driving signal according to the piece of first sensing data and the first control signal to adjust luminance of the controlled lamp. When the first automatic mode is performed, users transmit the configuration parameter to the lamp control module through the mobile device. When the lamp control module receives the piece of second sensing data transmitted from the optical sensor, the lamp control module generates the second driving signal according to the piece of second sensing data and the configuration parameter to instantly, adaptively and automatically adjust the luminance of the controlled lamp to maintain balanced indoor luminance and enhance operational convenience.

To achieve the foregoing objective, the indoor automatic dimming system performs an indoor automatic dimming system and includes an optical sensor, a mobile device, a lamp control module and a controlled lamp.

The optical sensor senses indoor luminance and outdoor luminance and has a first communication module.

The mobile device has a second communication module adapted to exchange information with a remote device.

The lamp control module has a third communication module connected to the optical sensor and the mobile device.

The controlled lamp is connected to the lamp control module for the lamp control module to adjust luminance of the controlled lamp.

The method has a first manual mode and a first automatic mode.

The first manual mode has steps of:

receiving a piece of first sensing data transmitted from the optical sensor and a first control signal transmitted from the mobile device through the lamp control module; and

generating a first driving signal for luminance adjustment through the lamp control module according to the piece of first sensing data and the first control signal.

The first automatic mode has steps of:

transmitting a configuration parameter configured by a user to the lamp control module through the mobile device; and

when the lamp control module receives a piece of second sensing data transmitted from the optical sensor, generating a second driving signal for luminance adjustment according to the piece of second sensing data and the configuration parameter through the lamp control module.

Given the foregoing system architecture, users can hold the mobile device and travel among different offices of all the floors or from office to office. The optical sensor, the lamp control module and the controlled lamp are provided to each office floor or in each office for the purpose of lighting. The optical sensor serves to sense indoor luminance and outdoor luminance. When the lamp control module receives the piece of first sensing data transmitted from the optical sensor through the first communication module and the mobile device transmits the control signal to the lamp control module through the second communication module, the lamp control module generates the first driving signal according to the piece of first sensing data and the first control signal to drive luminance of the controlled lamp. Moreover, the mobile device can transmit the configuration parameter configured by users to the lamp control module beforehand. If the mobile device already transmits the configuration parameter to the lamp control module, when the lamp control module continuously receives the piece of second sensing data transmitted from the optical sensor, the lamp control module generates the second driving signal according to the piece of second sensing data and the configuration parameter to instantly, adaptively and automatically drive the controlled lamp for luminance adjustment. Accordingly, detection of indoor and outdoor luminance ensures a balanced indoor luminance and operational convenience.

Other objectives, advantages and novel features of the invention will become more apparent from the following detailed description when taken in conjunction with the accompanying drawings.

### BRIEF DESCRIPTION OF THE DRAWINGS

FIG. 1 is a first embodiment of an indoor automatic dimming system in accordance with the present invention;

FIG. 2 is a second embodiment of an indoor automatic dimming system in accordance with the present invention;

FIG. 3 is a third embodiment of an indoor automatic dimming system in accordance with the present invention;

FIG. 4 is a fourth embodiment of an indoor automatic dimming system in accordance with the present invention;

FIG. 5 is a flow diagram of an embodiment of an automatic dimming method in accordance with the present invention; and

FIG. 6 is a flow diagram of another embodiment of an automatic dimming method in accordance with the present invention.

### DETAILED DESCRIPTION OF THE INVENTION

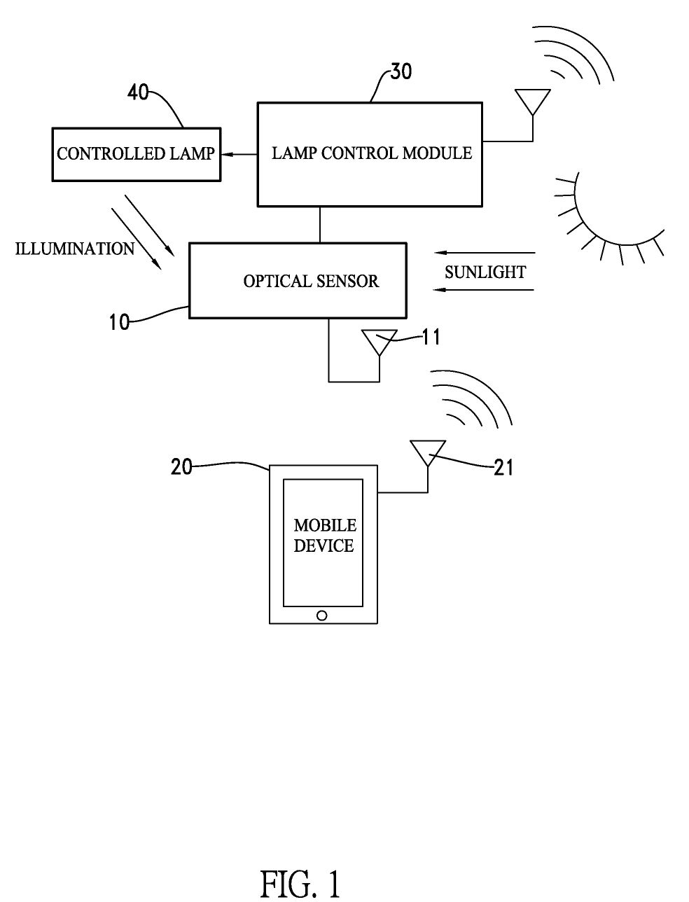

With reference to FIG. 1, a first embodiment of an indoor automatic dimming system in accordance with the present invention includes an optical sensor 10, a mobile device 20, a lamp control module 30 and a controlled lamp 40. The lamp control module 30 is connected to the optical sensor 10, the mobile device 20 and the controlled lamp 40, such that a user can hold the mobile device 20 and travel among different offices of all the floors or from office to office. The optical sensor 10, the lamp control module 30 and the controlled lamp 40 are provided to each office floor or in each office for the purpose of lighting. In the present embodiment, the optical sensor 10 is a smart phone and the mobile device 20 is another smart phone.

The optical sensor 10 serves to sense indoor light emitted from the controlled lamp 40 and outdoor natural light and convert the sensed indoor light and outdoor light into a data format. The optical sensor 10 has a first communication module 11. The mobile device 20 has a second communication module 21. The lamp control module 30 has a third communication module 31. The second communication module 21 of the mobile device 20 communicates with the lamp control module 30 according to a communication protocol to exchange data.

The optical sensor 10 and the lamp control module 30 can be connected through wired connection or wireless connection. The optical sensor 10 can directly transmit data to the lamp control module 30. Alternatively, the first communication module 11 of the optical sensor 10 can transmit data according to the communication protocol, and the third communication module 31 of the lamp control module 30 receives the data transmitted from the optical sensor 10. In the present embodiment, each of the first communication module 11, the second communication module 21 and the third communication module 31 is a WiFi® (Wireless Fidelity) module or a Bluetooth® module, and the communication protocol is a WiFi® protocol or a Bluetooth® protocol.

When the lamp control module 30 receives a piece of first sensing data transmitted from the optical sensor 10 and the second communication module 21 of the mobile device 20 transmits a first control signal to the third communication module 31 of the lamp control module 30, the lamp control module 30 generates a first driving signal for luminance adjustment according to the first piece of sensing data and the first control signal and transmits the first driving signal to the controlled lamp 40, such that users can directly drive the controlled lamp 40 for luminance adjustment through manual control over the mobile device 20.

Suppose that the second communication module 21 of the mobile device 20 transmits a configuration parameter configured by a user. Even if the user turns off the module device 20 after that, as the lamp control module 30 already receives and records the configuration parameter, when continuously receiving a piece of second sensing data transmitted from the optical sensor 10 all day long or over an entire season, the lamp control module 30 automatically and adaptively generates a second driving signal for luminance adjustment according to the piece of second sensing data and the configuration parameter and further transmits the second driving signal to the controlled lamp 40 to instantly drive the controlled lamp 40 for adequate lighting luminance.

In the present embodiment, the piece of first sensing data includes a first luminance value, the piece of second sensing data includes a second luminance value, and the configuration parameter includes a configured value or a piece of configuration data. When continuously receiving the piece of second sensing data transmitted from the optical sensor 10, the lamp control module 30 compares the piece of second sensing data with the configuration parameter. If a value of the piece of second sensing data is greater than the configuration parameter, the lamp control module 30 sends out the second driving signal for a decrease in luminance. If the value of the piece of second sensing data is less than the configuration parameter, the lamp control module 30 sends out the second driving signal for an increase in luminance.

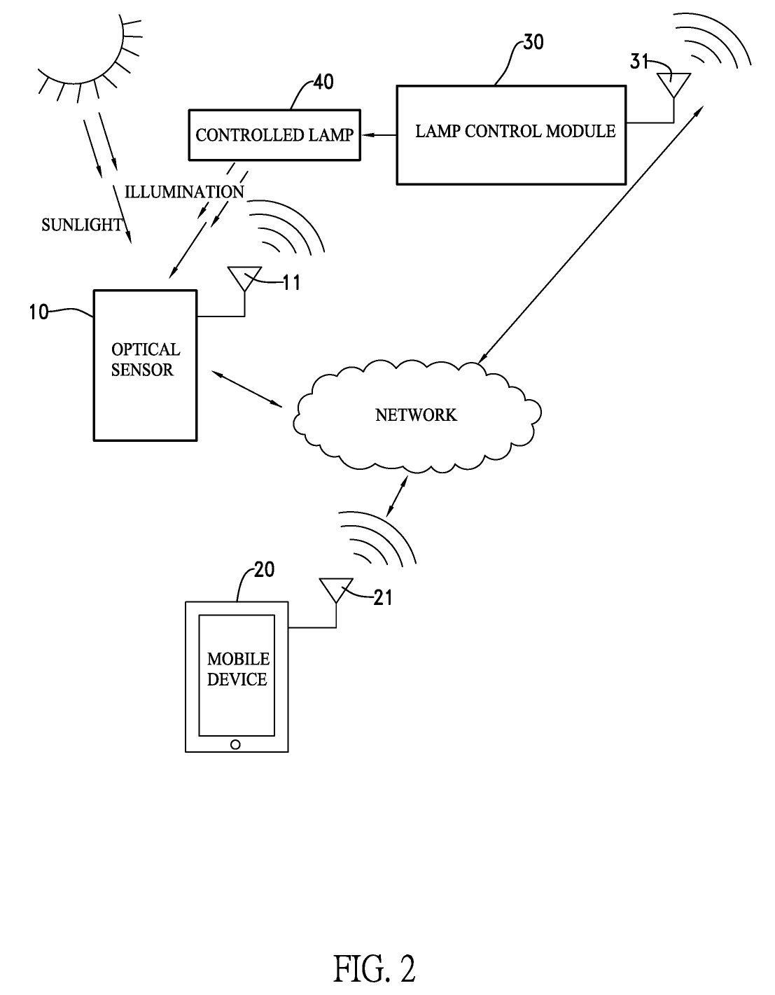

With reference to FIG. 2, a second embodiment of an indoor automatic dimming system in accordance with the present invention is substantially the same as the first embodiment except that the optical sensor 10 is wirelessly connected to the lamp control module 30, and the first communication module 11 of the optical sensor 10, the second communication module 21 of the mobile device 20 and the third communication module 31 of the lamp control module 30 are connected to a network through the communication protocol for information exchange through the network. Therefore, the optical sensor 10 may be installed at an appropriate location to enhance an effect and extend a communication range of the indoor automatic dimming system.

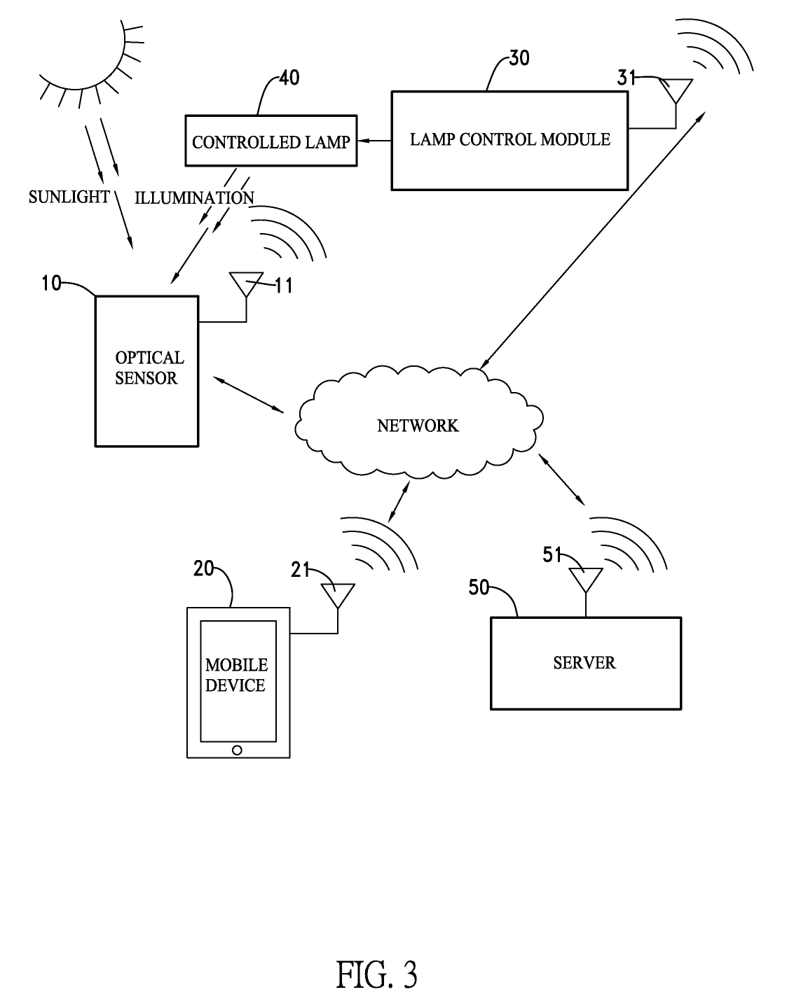

With reference to FIG. 3, a third embodiment of an indoor automatic dimming system in accordance with the present invention is substantially the same as the second embodiment except that a server 50 is additionally provided. The server 50 has a fourth communication module 51. In the present embodiment, the fourth communication module 51 is a WiFi® module or a Bluetooth® module. The fourth communication module 51 of the server 50 is connected to a network through the communication protocol for information exchange with the optical sensor 10, the mobile device 20 and the lamp control module 30.

The server 50 receives the piece of first sensing data transmitted from the optical sensor 10. The second communication module 21 of the mobile device 20 transmits a control signal to the server 50. When the server 50 transmits the piece of first sensing data and the first control signal to the lamp control module 30 through the network, the lamp control module 30 generates the first driving signal for luminance adjustment according to the piece of first sensing data and the first control signal and transmits the first driving signal to the controlled lamp 40, such that users can directly drive the controlled lamp 40 for luminance adjustment through manual control over the mobile device 20.

Suppose that the mobile device 20 transmits a configuration parameter configured by a user to the server 50. Even if the user turns off the mobile device 20 after that, as the server 50 already receives and records the configuration parameter, when continuously receiving a piece of second sensing data transmitted from the optical sensor 10 all day long or over an entire season, the lamp control module 30 automatically and adaptively generates the second driving signal for luminance adjustment according to the piece of second sensing data and the configuration parameter and further transmits the second driving signal to the controlled lamp 40 to instantly drive the controlled lamp 40 for adequate lighting luminance.

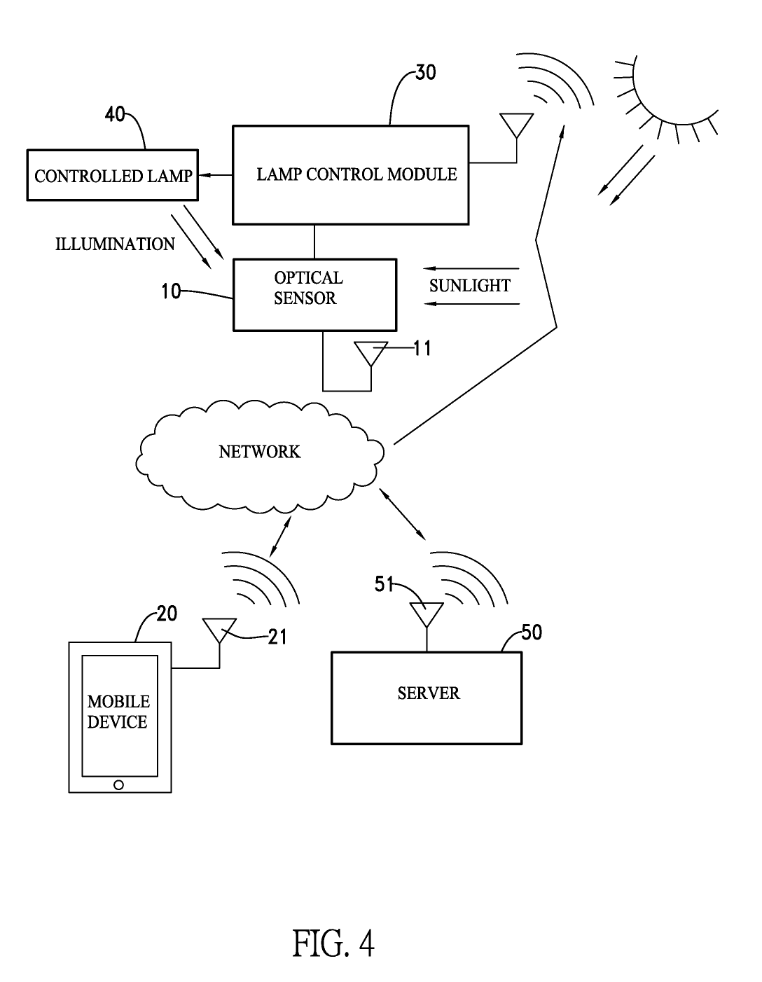

With reference to FIG. 4, a fourth embodiment of an indoor automatic dimming system in accordance with the present invention is substantially the same as the third embodiment except that the optical sensor 10 is wirelessly connected to the lamp control module 30. Hence, the optical sensor 10 can directly transmit the piece of first sensing data and the piece of second sensing data to the lamp control module 30 to increase operating effectiveness of the system.

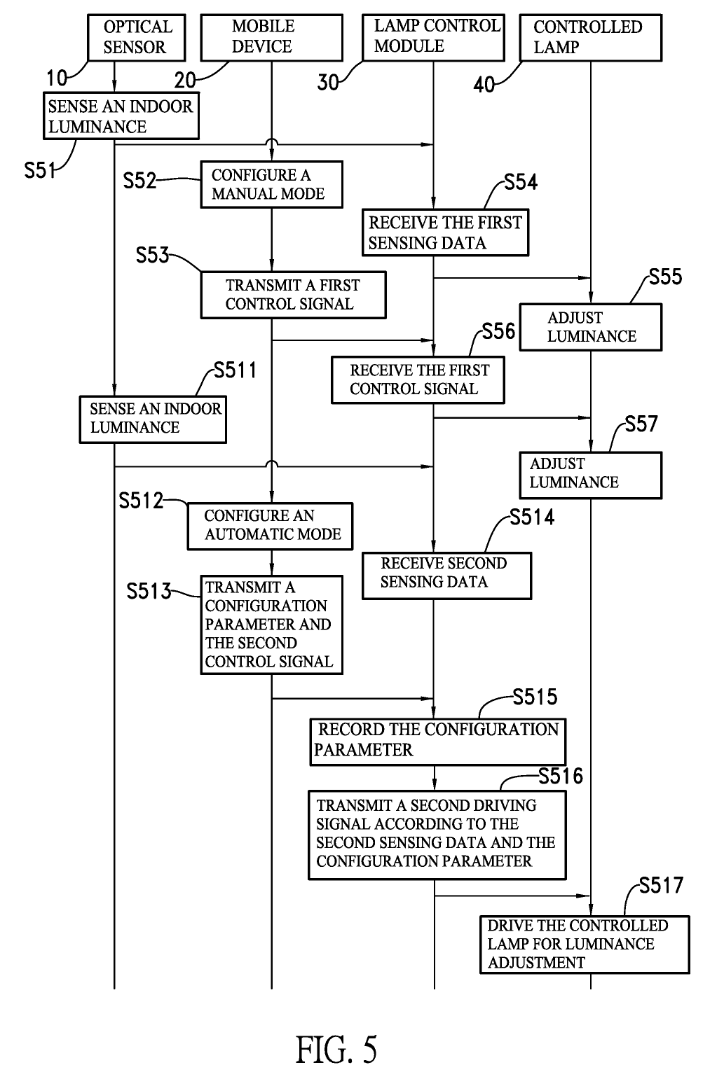

According to the foregoing embodiments and applications thereof, an indoor automatic dimming method adaptive to outdoor luminance can be deduced. The lamp control module 30 is connected to an optical sensor 10 for sensing indoor/outdoor luminance and the mobile device 20. The mobile device 20 performs data exchange with the lamp control module 30 through the communication protocol and provides a manual mode and an automatic mode. With reference to FIG. 5, when performing the manual mode, the indoor automatic dimming method includes the following steps.

Step S51: the optical sensor 10 senses an indoor luminance of the controlled lamp 40 and an outdoor luminance of outdoor natural light and transmits a piece of first sensing data to the lamp control module 30.

Step S52: A user configures the manual mode via the mobile device 20.

Step S53: The mobile device 20 transmits a first control signal to the lamp control module 30.

Step S54: The lamp control module 30 receives the piece of first sensing data transmitted from the optical sensor 10.

Step S55 and S57: The lamp control module 30 generates a first driving signal for luminance adjustment according to the piece of first sensing data and the first control signal and transmits the first driving signal to the controlled lamp 40 for the controlled lamp 40 to be driven for luminance adjustment.

S56: The lamp control module 30 receives the first control signal.

When performing the automatic mode, the indoor automatic dimming method includes the following steps.

Step S511: The optical sensor 10 continuously senses indoor/outdoor luminance and transmits a piece of second sensing data to the lamp control module 30.

Step S512: The user configures the automatic mode via the mobile device 20 and a configuration parameter, such as a preset value.

Step S513: The mobile device 20 transmits the configuration parameter and the second control signal to the lamp control module 30.

Step S514: The lamp control module 30 receives the piece of second sensing data transmitted from the optical sensor 10.

Step S515: The lamp control module 30 receives and records the configuration parameter.

Step S516: The lamp control module 30 generates a second driving signal for luminance adjustment according to the received piece of second sensing data and the configuration parameter.

Step S517: The lamp control module 30 transmits the second driving signal to the controlled lamp 40 for the controlled lamp 40 to be driven for luminance adjustment.

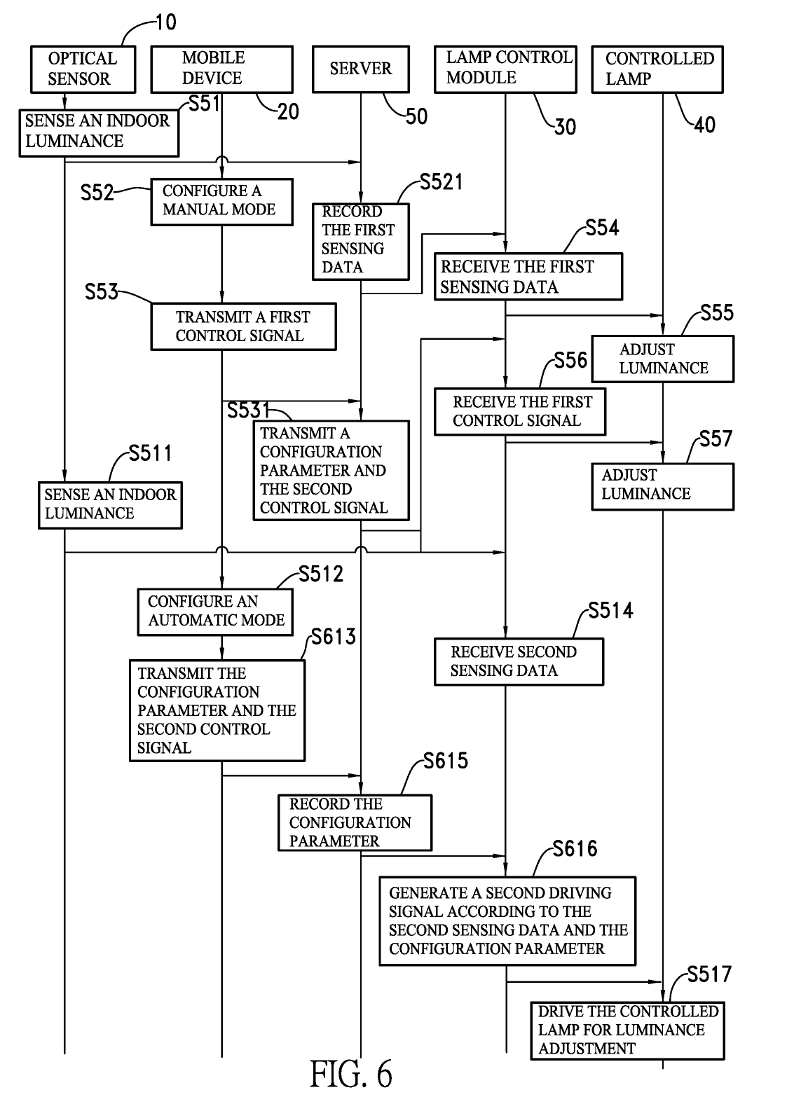

In the present embodiment a server 50 can be additionally provided in connection with the optical sensor 10, the mobile device 20 and the lamp control module 30 for information exchange therewith. With reference to FIG. 6, when performing the manual mode, the indoor automatic dimming method further includes the following steps.

Step S51: The optical sensor 10 senses an indoor luminance of the controlled lamp 40 and an outdoor luminance of outdoor natural light and transmits the piece of first sensing data to the server 50.

Step S52: A user configures the manual mode via the mobile device 20.

Step S53: The mobile device 20 transmits a first control signal to the server 50.

Step S521: The server 50 records the piece of first sensing data transmitted from the optical sensor 10.

Step S531: The server 50 records the first control signal.

Step S54: The lamp control module 30 receives the piece of first sensing data transmitted from the optical sensor 10.

Step S55 and S57: The lamp control module 30 generates a first driving signal for luminance adjustment according to the piece of first sensing data and the first control signal and transmits the first driving signal to the controlled lamp 40 for the controlled lamp 40 to be driven for luminance adjustment.

Step S56: The lamp control module 30 receives the first control signal transmitted from the server 50.

When performing the automatic mode, the indoor automatic luminance dimming method includes the following steps.

Step S511: The optical sensor 10 continuously senses indoor/outdoor luminance and transmits the piece of second sensing data to the lamp control module 30.

Step S512: The user configures the automatic mode via the mobile device 20 and a configuration parameter, such as a preset value.

Step S613: The mobile device 20 transmits the configuration parameter and the second control signal to the server 50.

Step S615: The server 50 receives and records the configuration parameter and transmits the configuration parameter, such as preset information, to the lamp control module 30.

Step S514: The lamp control module 30 receives the piece of second sensing data transmitted from the optical sensor 10 and the configuration parameter.

Step S616: The lamp control module 30 generates a second driving signal for luminance adjustment according to the received piece of second sensing data and the configuration parameter, such as the preset information.

Step S517: The lamp control module 30 transmits the second driving signal to the controlled lamp 40 for the controlled lamp 40 to be driven for luminance adjustment.

As can be seen from the foregoing description, users not only can hold the mobile device 20 and travel to each office floor or each office but also can employ the optical sensor 10, the lamp control module 30 and the controlled lamp 40 installed on each office floor or in each office for instant luminance adjustment. There are the manual mode and the automatic mode available to users. Sensed information and configuration information can be stored in a remote server 50. Even if the mobile device 20 is turned off, the indoor automatic dimming system can still be operated. Moreover, in the foregoing embodiments the piece of first sensing data includes a first luminance value. The piece of second sensing data includes a second luminance value. The configuration parameter includes the preset value or the preset information. When the lamp control module 30 continuously receives the piece of second sensing data transmitted from the optical sensor 10, the lamp control module 30 compares the piece of second sensing data with the configuration parameter. If a value of the piece of second sensing data is greater than the configuration parameter, the lamp control module 30 transmits the second driving signal for a decrease in luminance. If the value of the piece of second sensing data is less than the configuration parameter, the lamp control module 30 transmits the second driving signal for an increase in luminance. Accordingly, the present invention can instantly sense indoor/outdoor luminance to maintain a balanced luminance indoors and provide operational convenience.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. An indoor automatic dimming method adaptive to outdoor luminance, performed by an indoor automatic dimming system, wherein the indoor automatic dimming system has an optical sensor, a mobile device and a lamp control module, the lamp control module is connected to the optical sensor for sensing indoor and outdoor luminance and the mobile device, and the mobile device exchanges information with the lamp control module through a communication protocol, the method comprises a first manual mode and a first automatic mode;
wherein
the first manual mode comprises steps of:
receiving a piece of first sensing data transmitted from the optical sensor and a first control signal transmitted from the mobile device through the lamp control module; and
generating a first driving signal for luminance adjustment through the lamp control module according to the piece of first sensing data and the first control signal,
the first automatic mode comprises steps of:
transmitting a configuration parameter configured by a user to the lamp control module through the mobile device; and
when the lamp control module receives a piece of second sensing data transmitted from the optical sensor, generating a second driving signal for luminance adjustment according to the piece of second sensing data and the configuration parameter through the lamp control module.

2. (canceled)

3. The method as claimed in claim 1, wherein the piece of first sensing data includes a first luminance value, the piece of second sensing data includes a second luminance value, the configuration parameter includes a preset value or preset information, and the communication protocol is one of WiFi® (Wireless Fidelity) protocol and a Bluetooth® protocol.

4. The method as claimed in claim 3, wherein in the step of generating a second driving signal for luminance adjustment according to the piece of second sensing data and the configuration parameter, when the lamp control module continuously receives the piece of second sensing data transmitted from the optical sensor, the lamp control module compares the piece of second sensing data with the configuration parameter, when a value of the piece of second sensing data is greater than the configuration parameter, the lamp control module transmits the second driving signal for a decrease in luminance, and when the value of the piece of second sensing data is greater than the configuration parameter, the lamp control module transmits the second driving signal for an increase in luminance.

5. The method as claimed in claim 1, wherein the indoor automatic dimming system further has a server connected to the optical sensor, the mobile device and the lamp control module and performing a second manual mode, and the second manual mode comprises steps of:
transmitting the piece of first sensing data to the server through the optical sensor for the mobile device to transmit the first control signal to the server; and
receiving the piece of first sensing data and the first control signal transmitted from the server and generating the first driving signal for luminance adjustment according to the piece of first sensing data and the first control signal through the lamp control module.

6. The method as claimed in claim 3, wherein the indoor automatic dimming system further has a server connected to the optical sensor, the mobile device and the lamp control module and performing a second manual mode, and the second manual mode comprises steps of:
transmitting the piece of first sensing data to the server through the optical sensor for the mobile device to transmit the first control signal to the server; and
receiving the piece of first sensing data and the first control signal transmitted from the server and generating the first driving signal for luminance adjustment according to the piece of first sensing data and the first control signal through the lamp control module.

7. The method as claimed in claim 4, wherein the indoor automatic dimming system further has a server connected to the optical sensor, the mobile device and the lamp control module and performing a second manual mode, and the second manual mode comprises steps of:
transmitting the piece of first sensing data to the server through the optical sensor for the mobile device to transmit the first control signal to the server; and
receiving the piece of first sensing data and the first control signal transmitted from the server and generating the first driving signal for luminance adjustment according to the piece of first sensing data and the first control signal through the lamp control module.

8. The method as claimed in claim 1, wherein the indoor automatic dimming system further has a server connected to the optical sensor, the mobile device and the lamp control module and performing a second automatic mode, and the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

9. The method as claimed in claim 3, wherein the indoor automatic dimming system further has a server connected to the optical sensor, the mobile device and the lamp control module and performing a second automatic mode, and the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

10. The method as claimed in claim 4, wherein the indoor automatic dimming system further has a server connected to the optical sensor, the mobile device and the lamp control module and performing a second automatic mode, and the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

11. The method as claimed in claim 5, wherein the indoor automatic dimming system further has a server connected to the optical sensor, the mobile device and the lamp control module and performing a second automatic mode, and the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

12. The method as claimed in claim 6, wherein the indoor automatic dimming system further has a server connected to the optical sensor, the mobile device and the lamp control module and performing a second automatic mode, and the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

13. The method as claimed in claim 7, wherein the indoor automatic dimming system further has a server connected to the optical sensor, the mobile device and the lamp control module and performing a second automatic mode, and the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

14. An indoor automatic dimming system adaptive to outdoor luminance, performing an indoor automatic dimming method and comprising:
an optical sensor sensing indoor luminance and outdoor luminance and having a first communication module;
a mobile device having a second communication module adapted to exchange information with a remote device;
a lamp control module having a third communication module connected to the optical sensor and the mobile device; and
a controlled lamp connected to the lamp control module for the lamp control module to adjust luminance of the controlled lamp;
wherein the method has a first manual mode and a first automatic mode;
the first manual mode has steps of:
receiving a piece of first sensing data transmitted from the optical sensor and a first control signal transmitted from the mobile device through the lamp control module; and
generating a first driving signal for luminance adjustment through the lamp control module according to the piece of first sensing data and the first control signal; and
the first automatic mode has steps of:
transmitting a configuration parameter configured by a user to the lamp control module through the mobile device; and
when the lamp control module receives a piece of second sensing data transmitted from the optical sensor, generating a second driving signal for luminance adjustment according to the piece of second sensing data and the configuration parameter through the lamp control module.

15. The indoor automatic dimming system as claimed in claim 14, wherein the piece of first sensing data has a first luminance value, the piece of second sensing data has a second luminance value, the configuration parameter has a preset value or preset information, and the communication protocol is one of WiFi® (Wireless Fidelity) protocol and a Bluetooth® protocol.

16. The indoor automatic dimming system as claimed in claim 15, wherein in the step of generating a second driving signal for luminance adjustment according to the piece of second sensing data and the configuration parameter, when the lamp control module continuously receives the piece of second sensing data transmitted from the optical sensor, the lamp control module compares the piece of second sensing data with the configuration parameter, when a value of the piece of second sensing data is greater than the configuration parameter, the lamp control module transmits the second driving signal for a decrease in luminance, and when the value of the piece of second sensing data is greater than the configuration parameter, the lamp control module transmits the second driving signal for an increase in luminance.

17. The indoor automatic dimming system as claimed in claim 16, further comprising a server connected to the optical sensor, the mobile device and the lamp control module, wherein the method performs a second manual mode;
the second manual mode comprises steps of:
transmitting the piece of first sensing data to the server through the optical sensor for the mobile device to transmit the first control signal to the server; and
receiving the piece of first sensing data and the first control signal transmitted from the server and generating the first driving signal for luminance adjustment according to the piece of first sensing data and the first control signal through the lamp control module.

18. The indoor automatic dimming system as claimed in claim 17, wherein the method performs a second automatic mode;
the second automatic mode comprises steps of:
transmitting the configuration parameter to the server through the mobile device for the server to record the configuration parameter; and
receiving the piece of second sensing data transmitted from the optical sensor and the configuration parameter transmitted from the server and generating the second driving signal for luminance adjustment according to the piece of second sensing data and the configuration parameter through the lamp control module.

19. The indoor automatic dimming system as claimed in claim 14, wherein the optical sensor is a smart phone, the mobile device is a smart phone, and each of the first communication module, the second communication module and the third communication module is one of a WiFi® (Wireless Fidelity) module and a Bluetooth® module.

20. The indoor automatic dimming system as claimed in claim 15, wherein the optical sensor is a smart phone, the mobile device is a smart phone, and each of the first communication module, the second communication module and the third communication module is one of a WiFi® (Wireless Fidelity) module and a Bluetooth® module.

21. The indoor automatic dimming system as claimed in claim 16, wherein the optical sensor is a smart phone, the mobile device is a smart phone, and each of the first communication module, the second communication module and the third communication module is one of a WiFi® (Wireless Fidelity) module and a Bluetooth® module.

22. The indoor automatic dimming system as claimed in claim 17, wherein the optical sensor is a smart phone, the mobile device is a smart phone, and each of the first communication module, the second communication module and the third communication module is one of a WiFi® (Wireless Fidelity) module and a Bluetooth® module.

23. The indoor automatic dimming system as claimed in claim 18, wherein the optical sensor is a smart phone, the mobile device is a smart phone, and each of the first communication module, the second communication module and the third communication module is one of a WiFi® (Wireless Fidelity) module and a Bluetooth® module.
